(19) United States
(12) Patent Application Publication
(10) Pub. No.: US 2013/0212941 A1
(43) Pub. Date: Aug. 22, 2013

(54) INTERLOCKING ROOFING TRAYS

(71) Applicant: Firestone Building Products Co, LLC, (US)

(72) Inventor: S. Riaz HASAN, Noblesville, IN (US)

(21) Appl. No.: 13/852,451

(22) Filed: Mar. 28, 2013

Related U.S. Application Data
(62) Division of application No. 12/948,873, filed on Nov. 18, 2010.
(60) Provisional application No. 61/262,195, filed on Nov. 18, 2009.

(51) Int. Cl. A01G 1/00

(52) U.S. Cl. CPC A01G 1/007
USPC 47/65.9

(57) ABSTRACT

An interlocking roof tray adapted for placement on a roof surface and including a bottom surface and sidewalls defining an interior region of the tray. A dovetail projection extends outwardly away from the interior region in one sidewall, and a dovetail recess extends inwardly into the interior region in a sidewall opposite the dovetail projection. An interlocking roof tray assembly is formed from a plurality of the roof trays. Adjacent interlocking roof trays are secured together by dovetail joints formed form the dovetail projections and dovetail recesses.

This application is a Divisional Application of U.S. Non-Provisional Application Ser. No. 12/948,873, filed on Nov. 18, 2010, which claims the benefit of U.S. Provisional Application Ser. No. 61/262,195 filed on Nov. 18, 2009, which are incorporated herein by reference.

### FIELD OF THE INVENTION

One or more embodiments of the present invention relate to an interlocking roofing tray adapted to contain vegetation. In other embodiments a roofing assembly may be provided including a plurality of the interlocking roofing trays positioned over a roofing membrane.

### BACKGROUND OF THE INVENTION

The construction industry commonly uses single ply membranes to provide a waterproof barrier on flat or low-slope roofs. Because it is expensive and difficult to produce and transport a single membrane sized to cover an entire roof surface, a roof is typically covered by a plurality of individual membranes oriented in an overlapping arrangement. The overlapping portions, or splices, of the individual membrane panels are secured together to form a single waterproof surface.

There is not only a need to attach the various membrane panels together in order to form a continuous waterproof surface, but there is also a need to secure the membrane to a roof substrate. Various attachment techniques are employed in the art. For example, membrane panels can be fully adhered to the roof substrate (or to an intermediary surface, such as a roof insulation, that has been secured to the roof substrate). In certain situations, membrane panels include a factory applied adhesive layer substantially covering one planar surface of the panel. In other situations, attachment strips are secured to the roof or an intermediary layer of a roofing system by mechanical means (such as by use of a fastener and plate or a batten strip). In still other situations, membrane panels are secured to a roof deck or intermediary layer of a roofing system by employing mechanical means that directly engage or secure the membrane panel. Because these fastening systems pierce the membrane panel, they must be covered to ensure the waterproof integrity of the membrane system.

Another method of attachment involves using weighted objects placed upon the membrane to secure it over a roof substrate. Objects commonly placed on the membrane include ballast pavers, rocks, and planting pots. The weight of these objects counters wind uplift forces acting on the membrane, and prevents the membrane from moving relative to the roof substrate or insulation layer thereunder. In addition, roofing trays are sometimes placed on the membrane to secure it in place. The roofing trays are adapted to be filled with dirt and plants once positioned on the roof surface.

Roofing trays containing vegetation offer a number of advantages over other methods of adhering a roofing membrane to the roof substrate: The roofing trays extend the longevity of traditional roofing membranes by providing a protective cover; they are environmentally friendly; they help to control temperatures within the building; they absorb rain water; and they allow for easy maintenance and/or replacement of the roofing membrane. However, known roofing trays suffer from a number of disadvantages. Many roofing trays commercially available require mechanical fasteners to secure one tray to an adjacent tray. In addition, many known roofing trays that are available commercially are complicated and therefore difficult and expensive to manufacture.

Thus, there is a need for an improved roofing tray that is simple in construction, easy to install, and provides an efficient way to interlock adjacent trays together.

### SUMMARY OF THE INVENTION

One or more embodiments of the present invention provide an interlocking roof tray adapted for placement on a rood surface, the tray comprising: a bottom surface having a periphery; a plurality of sidewalls extending from said periphery of said bottom surface and defining an interior region; a dovetail projection extending outwardly away from said interior region in one of said sidewalls; and a dovetail recess extending inwardly into said interior region in a sidewall opposite said dovetail projection..

One or more embodiments of the present invention also provides an interlocking roof tray assembly comprising a plurality of interlocking roof trays, wherein adjacent roof trays are secured together by a dovetail joint.

One or more embodiments of the present invention also provides a roofing assembly comprising: a roof substrate; a roofing membrane positioned over said roof substrate; a plurality of interlocking roof trays positioned on said membrane; and vegetation planted in said roofing trays, wherein said membrane is secured on said roof substrate by virtue of the weight of said interlocking roof trays and said vegetation and without the use of any adhesive or mechanical fasteners.

### BRIEF DESCRIPTION OF THE DRAWINGS

FIG. 1 is a perspective view of an interlocking green tray according to the concepts of the present invention;

FIG. 2 is an elevational top view of the interlocking roof tray of FIG. 1;

FIG. 3 is an enlarged view of a portion of the interlocking roof tray as indicated in FIG. 2.

FIG. 4 is an elevational top view showing a plurality of interlocking roof trays secured together; and

FIG. 5 is a sectional view of a roofing assembly including the interlocking green trays of the present invention.

### DETAILED DESCRIPTION OF THE ILLUSTRATIVE EMBODIMENTS

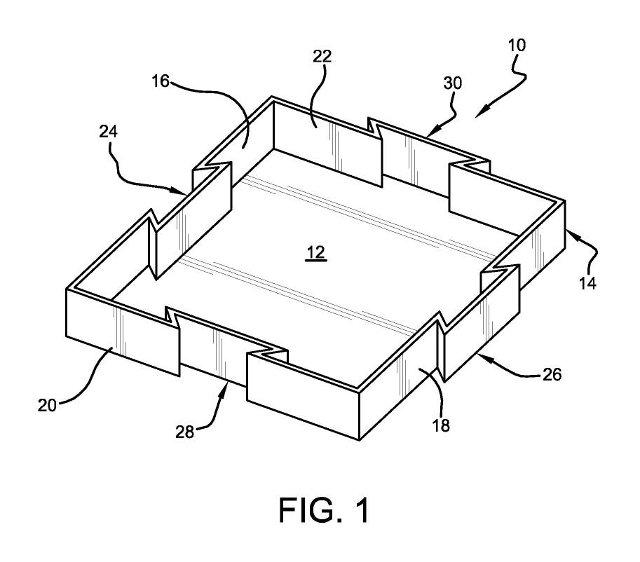

Referring now to FIG. 1, an interlocking roof tray is shown, and is generally indicated by the numeral 10. In one or more embodiments, interlocking roof tray 10 includes a bottom surface 12 having an outer periphery and sidewalls 14 extending upwardly from the outer periphery of bottom surface 12 to define an inner region. While the specific embodiment of roof tray 10 shown in the drawings includes a bottom surface 12 having a generally rectangular shape, it should be appreciated that other shapes may be provided.

In one or more embodiments, sidewalls 14 include a first longitudinal side wall 16 extending from a longitudinal edge of bottom surface 12, and a second longitudinal sidewall 18 extending from the other longitudinal edge of bottom surface 12. A first lateral sidewall 20 and a second lateral sidewall 22 extend between first longitudinal sidewall 16 and second longitudinal sidewall 18 along the lateral edges of bottom surface 12. In one or more embodiments, sidewalls 14 may be generally perpendicular with bottom surface 12.

In one or more embodiments, first longitudinal sidewall 16 includes a first dovetail recess 24 extending inwardly toward the inner region defined by sidewalls 14. Second longitudinal sidewall 18 includes a first dovetail projection 26 extending outwardly, or in the same direction as first dovetail recess 24. In one or more embodiments, first lateral sidewall 20 includes a second dovetail recess 28 extending inwardly into the inner region defined by sidewalls 14. Second lateral sidewall 22 includes a second dovetail projection 30 extending outwardly, or in the same direction as second dovetail recess 28.

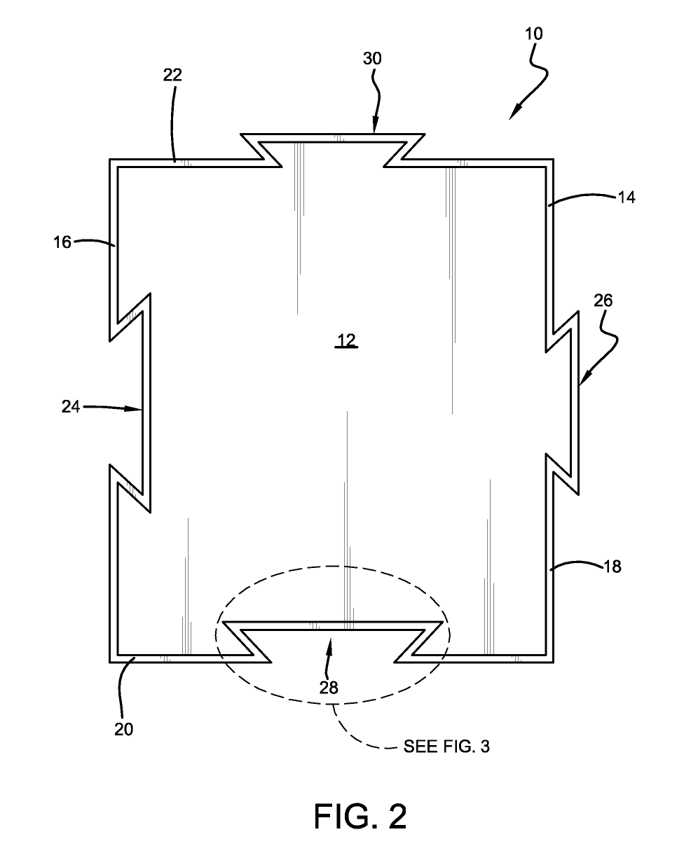

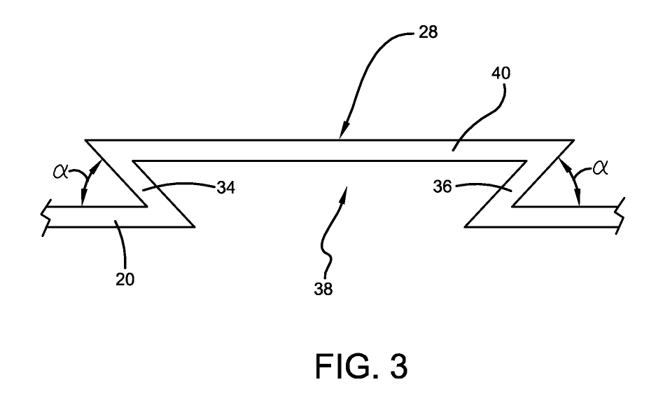

Each dovetail recess and projection 24, 26, 28, and 30 define an area, when viewed from above as shown in FIG. 2, of an isosceles trapezoid. Thus, each recess and projection includes a first leg 34 and a second leg 36 extending from opposing sides of an opening 38 in one of the sidewalls 18, 20, 22, 24. As best shown in FIG. 3, first leg 34 and second leg 36 both extend at an equal angle a relative to sidewall 20 (or sidewalls 18, 22, or 24). First leg 34 and second leg 36 are connected by a dovetail face 40 extending therebetween and positioned opposite sidewall 20. In one or more embodiments, dovetail face 40 is generally parallel with sidewall 20.

First dovetail recess 24 has inner dimensions that are approximately equal to but slightly larger than the outer dimensions of first dovetail projection 26. This slight difference in size allows for the dovetail projection of an adjacent roof tray 10 to fit in first dovetail recess 24. Similarly, the inner dimensions of second dovetail recess 28 are approximately equal to but slightly larger than the outer dimensions of second dovetail projection 30. In one or more embodiments, first dovetail recess 24 and second dovetail recess 28 may have the same dimensions.

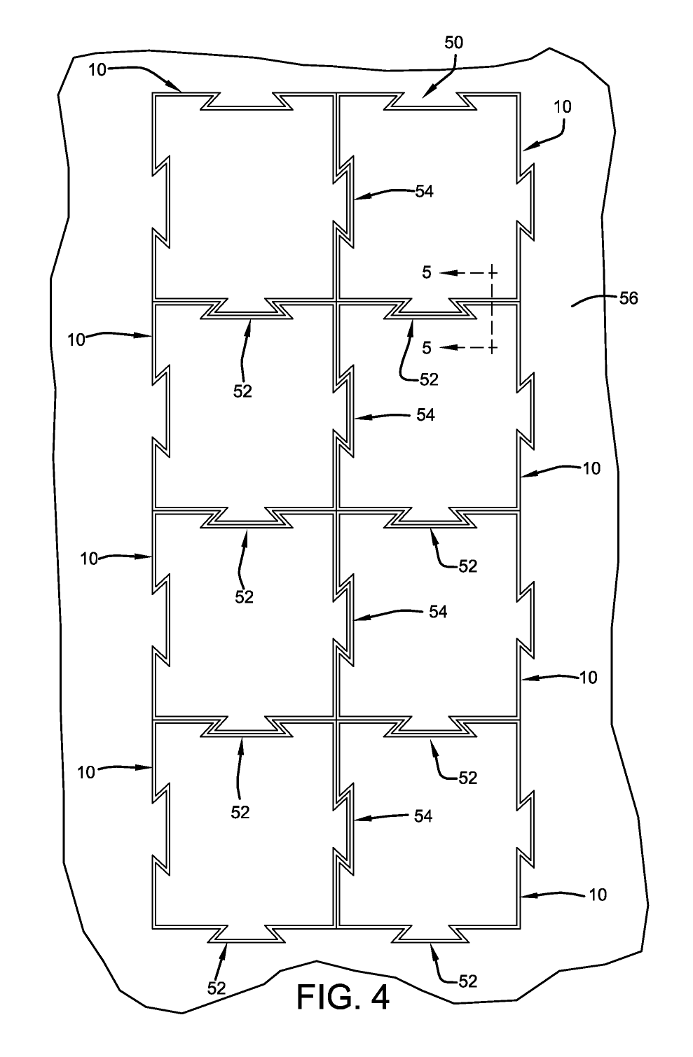

Referring now to FIG. 4, an interlocking roof tray assembly, generally indicated by the numeral 50, is shown positioned on a roofing membrane 56. Roof tray assembly 50 includes a plurality of interlocking roof trays 10 secured together by virtue of the interlocking dovetail recesses and dovetail projections provided on each. While eight roof trays 10 are shown in FIG. 4 arranged in a generally rectangular assembly, it should be appreciated that any number of interlocking roof trays 10 may be secured together to form roof tray assembly 50. It should also be appreciated that interlocking roof trays 10 may be provided in any arrangement desired.

In one or more embodiments, each longitudinal interface between adjacent roof trays 10 in roof tray assembly 50 includes a longitudinal dovetail joint 52. Each longitudinal dovetail joint 52 includes a dovetail projection that is received in a dovetail recess. This type of attachment method does not require any other adhesive or fasteners to secure the adjacent roof trays 10 together. In one or more embodiments, each lateral interface between adjacent roof trays 10 in roof tray assembly 50 includes a lateral dovetail joint 54 similar to the longitudinal dovetail joint 52. Each lateral dovetail joint 54 includes a lateral dovetail projection that is received in a lateral dovetail recess. As will be appreciated by those skilled in the art, interlocking roof tray assembly 50 provides a large area in which to plant vegetation, while simultaneously securing roofing membrane 56 to the roof surface.

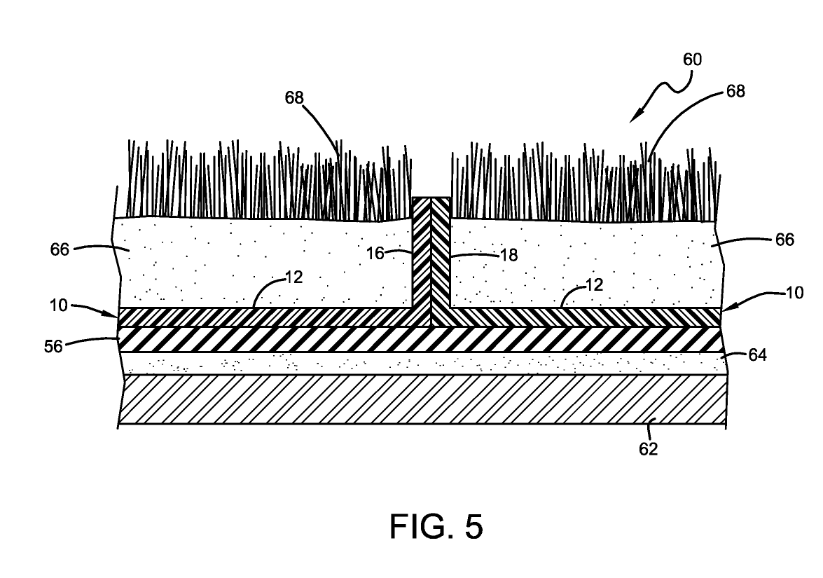

A roofing assembly, generally indicated by the numeral 60, including interlocking roof trays 10, is shown in FIG. 5. In one or more embodiments, roofing assembly 60 includes a roof substrate 62 which supports the other components of the roofing assembly. In one or more embodiments, an insulation layer 64 may be provided over roof substrate 62. Insulation layer 64 may be provided in any form known to those skilled in the art, and may be, for example, a polyisocyanurate foam board. In one or more embodiments, the insulation layer 64 may be secured to roof substrate 62 by any method known in the art, including by mechanical fasteners or with the use of adhesives.

In one or more embodiments, a roofing membrane 56 is provided over insulation layer 64 or roof substrate 62. Suitable membranes are well known in the art of roofing systems, and may include, for example, a thermoplastic or thermo-set membrane. In one or more embodiments, roofing membrane 56 may be an EPDM based material. In other embodiments, roofing membrane 56 may be a TPO based material. Roofing membrane 56 is held in place on insulation 64 or roof substrate 62 by virtue of the weight of roofing trays 10 and the material contained therein.

In one or more embodiments, roofing trays 10 are filled with dirt or potting soil 66 suitable for supporting vegetation. In these or other embodiments, geographically appropriate vegetation 68 may be provided in roofing trays 10 and planted in the soil 66. The vegetation 68 contained in roofing trays 10 acts to absorb moisture in the trays provided by rain water, and also acts to help insulate the space beneath roof substrate 62.

Various modifications and alterations that do not depart from the scope and spirit of this invention will become apparent to those skilled in the art. This invention is not to be unduly limited to the illustrative embodiments set forth herein.

1-17. (canceled)

18. A roofing assembly comprising:
a roof substrate;
a roofing membrane positioned over said roof substrate;
a plurality of interlocking roof trays positioned on said membrane; and
vegetation planted in said interlocking roofing trays, wherein said membrane is secured on said roof substrate by virtue of the weight of said interlocking roof trays and said vegetation without the use of any adhesive or mechanical fasteners.

19. The roofing assembly of claim 18, wherein adjacent interlocking roof trays are secured together by a dovetail joint.

20. The roofing assembly of claim 19, wherein each interlocking roof tray includes a bottom surface having a periphery, a plurality of sidewalls extending from said periphery of said bottom surface and defining an interior region, a dovetail projection extending outwardly away from said interior region in one of said sidewalls, and a dovetail recess extending inwardly into said interior region in a sidewall opposite said dovetail projection; and wherein said dovetail recess and said dovetail projection of adjacent roof trays form said dovetail joint.

21. The roofing assembly of claim 20, wherein said dovetail projection contains a portion of said interior region.

22. The roofing assembly of claim 21, wherein said sidewalls have a contiguous uninterrupted height to define said interior region.

23. The roofing assembly of claim 22, wherein said contiguous uninterrupted height is less than any length of said bottom surface.

24. The roofing assembly of claim 23, wherein each said dovetail projection and each said dovetail recess extends from said bottom surface to a top edge of said sidewall.
